(19) United States
(12) Patent Application Publication
(10) Pub. No.: US 2022/0068075 A1
(43) Pub. Date: Mar. 3, 2022

(54) METHODS AND APPARATUSES FOR CREATING TIMES CARD VOUCHER AND METHODS AND APPARATUSES FOR WRITING OFF TIMES CARD VOUCHER

(71) Applicant: KOUBEI (SHANGHAI) INFORMATION TECHNOLOGY CO., LTD., Shanghai (CN)

(72) Inventors: Shicheng ZHOU, Shanghai (CN); Xiaoyu HU, Shanghai (CN); Xinmeng WANG, Shanghai (CN)

(21) Appl. No.: 17/506,948

(22) Filed: Oct. 21, 2021

Related U.S. Application Data
(63) Continuation of application No. PCT/CN2020/082507, filed on Mar. 31, 2020.

(30) Foreign Application Priority Data
Apr. 22, 2019 (CN) 201910325296.7

(51) Int. Cl. G07F 7/02

(52) U.S. Cl. CPC G07F 7/025

(57) ABSTRACT

The present disclosure provides methods and apparatuses for creating a times card voucher and methods and apparatuses for writing off a times card voucher. The method includes: receiving an acquisition request for a times card; creating a primary voucher and at least one secondary voucher corresponding to the times card based on the acquisition request, wherein a number of the at least one secondary voucher is consistent with a number of times of use authorized for the times card; generating at least one of a first write-off code corresponding to the primary voucher, or a second write-off code corresponding to the at least one secondary voucher, so as to write off the at least one secondary voucher.

### CROSS REFERENCE TO RELATED APPLICATIONS

This application is a continuation of International Application No. PCT/CN2020/082507, filed Mar. 31, 2020, which claims priority to Chinese Patent Application No. 2019103252967 entitled “METHODS AND APPARATUSES FOR CREATING TIMES CARD VOUCHER AND METHODS AND APPARATUSES FOR WRITING OFF TIMES CARD VOUCHER” filed with the China Patent Office on Apr. 22, 2019, the entire contents of the above-referred applications are incorporated herein by reference.

### TECHNICAL FIELD

The present disclosure relates to the field of internet technologies, and in particular to methods and apparatuses for creating a times card voucher, as well as methods and apparatuses for writing off a times card voucher.

### BACKGROUND

Along with development of internet technologies, selling merchandise or services online has become a popular trend. A times card can be used for consumption in a unit of number of times, and can lock up consumption in advance and increase a consumption rate of users.

In the prior art, when a user purchases a times card from an online platform, a unique electronic voucher corresponding to the times card may be generated to record a number of times of use authorized for the times card. Every time the user carries out one consumption, one write-off (i.e., cancel after verification) may be performed for the electronic voucher and a remaining number of times is updated correspondingly.

However, in the manner in which the electronic voucher is created in the prior art, only one electronic voucher is generated, and correspondingly, the write-off is performed only for the unique electronic voucher, easily leading to wrong write-off, affecting the accuracy of a write-off result, and bringing poor experiences to users.

### SUMMARY

Based on the above, the present disclosure provides methods and apparatuses for creating a times card voucher and methods and apparatuses for writing off a times card voucher, so as to solve, in part or wholly, the above technical problems.

According to a first aspect of the present disclosure, provided is a method of creating a times card voucher, including:

receiving an acquisition request for a times card; creating a primary voucher and at least one secondary voucher corresponding to the times card based on the acquisition request, where a number of the at least one secondary voucher is consistent with a number of times of use authorized for the times card; and generating at least one of a first write-off code corresponding to the primary voucher, or a second write-off code corresponding to the at least one secondary voucher, so as to write off the at least one secondary voucher.

According to another aspect of the present disclosure, provided is a method of writing off a times card voucher, including:

according to a write-off request for at least one secondary voucher of a times card, analysing a write-off code carried in the write-off request; where the write-off code is a first write-off code corresponding to a primary voucher of the times card or a second write-off code corresponding to one secondary voucher of the at least one secondary voucher of the times card; and a number of the at least one secondary voucher is consistent with a number of times of use authorized for the times card; and selecting a to-be-written-off secondary voucher from the at least one secondary voucher corresponding to the times card based on an analysis result to write off the to-be-written-off secondary voucher.

According to another aspect of the present disclosure, provided is a method of writing off a times card voucher, including:

receiving an acquisition request for a times card; creating a primary voucher and at least one secondary voucher corresponding to the times card based on the acquisition request, where a number of the at least one secondary voucher is consistent with a number of times of use authorized for the times card; according to a write-off request for the at least one secondary voucher of the times card, analysing a write-off code carried in the write-off request; where the write-off code is a first write-off code corresponding to the primary voucher of the times card or a second write-off code corresponding to one secondary voucher; and selecting a to-be-written-off secondary voucher from the at least one secondary voucher corresponding to the times card based on an analysis result to write off the to-be-written-off secondary voucher.

According to an aspect of the present disclosure, provided is an apparatus for creating a times card voucher, including:

a receiving module, configured to receive an acquisition request for a times card; a creating module, configured to create a primary voucher and at least one secondary voucher corresponding to the times card based on the acquisition request, where a number of at least one secondary voucher is consistent with a number of times of use authorized for the times card; and a generating module, configured to generate at least one of a first write-off code corresponding to the primary voucher, or a second write-off code corresponding to the at least one secondary voucher, so as to write off the at least one secondary voucher.

According to another aspect of the present disclosure, provided is an apparatus for writing off a times card voucher, including:

an analysing module, configured to, according to a write-off request for at least one secondary voucher of a times card, analyse a write-off code carried in the write-off request; where the write-off code is a first write-off code corresponding to a primary voucher of the times card, or a second write-off code corresponding to one secondary voucher of the at least one secondary voucher of the times card; and a number of the at least one secondary voucher is consistent with a number of times of use authorized for the times card; a selecting module, configured to select a to-be-written-off secondary voucher from the at least one secondary voucher corresponding to the times card based on an analysis result; and a writing-off module, configured to write off the to-be-written-off secondary voucher.

According to another aspect of the present disclosure, provided is a system for writing off a times card voucher, including the apparatus for creating a times card voucher according to any one above aspect and the apparatus for writing off a times card voucher according to any one above aspect.

According to an aspect of the present disclosure, provided is a computing device, including a processor, a memory, a communication interface and a communication bus, where the processor, the memory and the communication interface communicate with each other via the communication bus; the memory is configured to store at least one executable instruction which causes the processor to perform operations corresponding to the above method of creating a times card voucher.

According to another aspect of the present disclosure, provided is a computing device, including a processor, a memory, a communication interface and a communication bus, where the processor, the memory and the communication interface communicate with each other via the communication bus; the memory is configured to store at least one executable instruction which causes the processor to perform operations corresponding to the above method of writing off a times card voucher.

According to another aspect of the present disclosure, provided is a non-volatile computer readable storage medium, storing at least one executable instruction which causes a processor to perform operations corresponding to the above method of creating a times card voucher.

According to another aspect of the present disclosure, provided is a computer program product, including computer programs stored in a non-volatile computer storage medium, where the computer programs include program instructions which are executed by a processor to perform operations corresponding to the above method of creating a times card voucher.

According to another aspect of the present disclosure, provided is a non-volatile computer readable storage medium, storing at least one executable instruction which causes a processor to perform operations corresponding to the above method of writing off a times card voucher.

According to another aspect of the present disclosure, provided is a computer program product, including computer programs stored in a non-volatile computer storage medium, where the computer programs include program instructions which are executed by a processor to perform operations corresponding to the above method of writing off a times card voucher. In the methods and apparatuses for creating a times card voucher, and methods and apparatuses for writing off a times card voucher, when an acquisition request for a times card is received, a primary voucher and at least one secondary voucher corresponding to the times card are created rather than only creating one unique voucher; by generating a first write-off code corresponding to the primary voucher or a second write-off code corresponding to at least one secondary voucher, a write-off can be performed for the at least one secondary voucher rather than for the created unique voucher. Therefore, the embodiments of the present disclosure provide an all-new solution of creating a times card voucher, in which one secondary voucher of the at least one secondary voucher created corresponding to the times card can be subjected to one write-off, such that the write-off process may be more stable and orderly, thus improving accuracy of a write-off result.

The above descriptions are only a summary for the technical solutions of the present disclosure. In order to help understand the technical approaches of the present disclosure more clearly, the present disclosure can be practiced based on the contents of the specification. Further, in order to make the above and other objects, features and advantages of the present disclosure clearer and more understandable, the following descriptions are made with specific embodiments.

### BRIEF DESCRIPTION OF DRAWINGS

After reading the detailed descriptions of the embodiments of the present disclosure, various other advantages and benefits will become apparent to those skilled in the part. The accompanying drawings are only for the purpose of illustrating some embodiments rather than limiting the present disclosure. In all the accompanying drawings, like reference numerals refer to like components.

FIG. 1 is a flowchart illustrating a method of creating a times card voucher according to an embodiment of the present disclosure.

FIG. 2 is a flowchart illustrating a method of writing off a times card voucher according to an embodiment of the present disclosure.

FIG. 3 is a flowchart illustrating a method of writing off a times card voucher according to another embodiment of the present disclosure.

FIG. 4 is a flowchart illustrating a method of writing off a times card voucher according to another embodiment of the present disclosure.

FIG. 5 is a schematic diagram of creating a times card voucher according to a specific embodiment of the present disclosure.

FIG. 6 is a schematic diagram of selecting a secondary voucher for write-off according to a specific embodiment of the present disclosure.

FIG. 7 is a flowchart illustrating a method of writing off a times card voucher according to yet another embodiment of the present disclosure.

FIG. 8 is a schematic diagram of displaying a fixed code or variable code at a user side according to a specific embodiment of the present disclosure.

FIG. 9 is a functional block diagram illustrating an apparatus for creating a times card voucher according to an embodiment of the present disclosure.

FIG. 10 is a functional block diagram illustrating an apparatus for writing off a times card voucher according to an embodiment of the present disclosure.

FIG. 11 is a structural schematic diagram illustrating a computing device according to an embodiment of the present disclosure.

FIG. 12 is a structural schematic diagram illustrating another computing device according to an embodiment of the present disclosure.

FIG. 13 is a structural schematic diagram illustrating yet another computing device according to an embodiment of the present disclosure.

### DETAILED DESCRIPTION

The exemplary embodiments of the present disclosure will be further detailed below with reference to the accompanying drawings. Although the accompanying drawings show the exemplary embodiments of the present disclosure, it should be understood that the present disclosure can be implemented in various forms rather than limited to these embodiments described herein. Conversely, these embodiments are provided to realize a more thorough understanding of the present disclosure and convey the scope of the present disclosure fully to those skilled in the art.

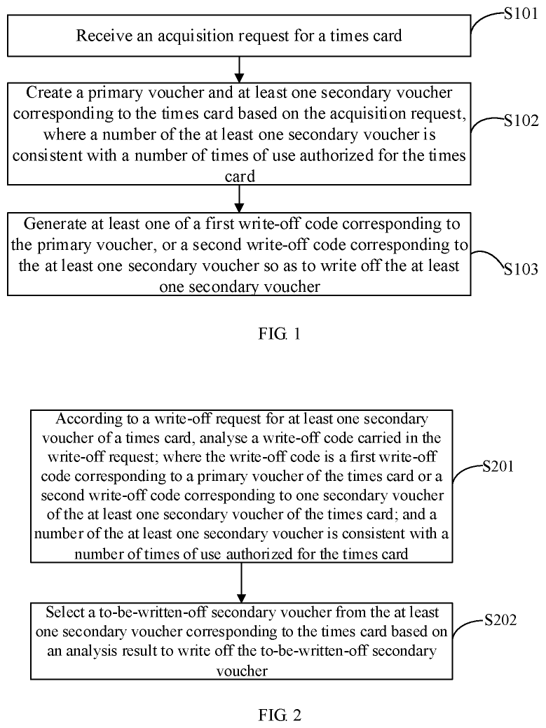

FIG. 1 is a flowchart illustrating a method of creating a times card voucher according to an embodiment of the present disclosure. The method is performed by a voucher system of an online platform. As shown in FIG. 1, the method includes the following steps.

At step S101, an acquisition request for a times card is received.

The acquisition request may be initiated by a user, for example, a user may initiate an acquisition request when purchasing or receiving the times card; alternatively, the acquisition request may be initiated by an online platform, for example, the online platform may initiate an acquisition request when presenting the times card to a user, which is not limited herein.

At step S102, a primary voucher and at least one secondary voucher corresponding to the times card are created based on the acquisition request, where a number of the at least one secondary voucher is consistent with a number of times of use authorized for the times card.

In the present disclosure, corresponding to one times card, one primary voucher is created and at least one secondary voucher consistent with the number of times of use authorized for the times card is created at the same time. For example, a user purchases a times card a from a beauty saloon and the times card a can be used for three beatification consumptions. In this case, it is to create one primary voucher and three secondary vouchers corresponding to the times card α.

Specifically, an acquisition request for the times card is received, and a primary voucher corresponding to the times card is created according to times card detail information carried in the acquisition request, where the times card detail information includes shop information, merchandise information, and/or service information, the primary voucher records information about the number of times of use authorized for the times card, and/or, voucher information of at least one secondary voucher of a same times card associated with the primary voucher. The information about the number of times of use authorized for the times card may further include the number of times of use authorized for the times card and a remaining number of times of use, and the voucher information includes a voucher identifier and a write-off state. Furthermore, at least one secondary voucher corresponding to the times card is created and used for each write-off.

At step S103, at least one of a first write-off code corresponding to the primary voucher, or a second write-off code corresponding to the at least one secondary voucher is generated so as to write off the at least one secondary voucher.

Specifically, the first write-off code corresponding to the primary voucher is generated, and then a to-be-written-off secondary voucher is selected for write-off from the at least one secondary voucher according to a correspondence between the primary voucher pointed to by the first write-off code and the at least one secondary voucher, where there is a correspondence between the primary voucher and the secondary voucher of a same times card. Alternatively, the second write-off code corresponding to the at least one secondary voucher is generated, and then a to-be-written-off secondary voucher is determined for write-off directly from the at least one secondary voucher based on a secondary voucher pointed to by the second write-off code. In other words, in this embodiment, by using the created times card voucher and the write-off code corresponding to the times card voucher, the write-off may be performed for one secondary voucher rather than for a same voucher during each write-off.

In the method of creating a times card voucher according to this embodiment, when an acquisition request for a times card is received, a primary voucher and at least one secondary voucher corresponding to the times card are created rather than only creating one unique voucher; by generating at least one of a first write-off code corresponding to the primary voucher or a second write-off code corresponding to the at least one secondary voucher, a write-off can be performed for the at least one secondary voucher rather than for the created unique voucher. Therefore, in the embodiment, an all-new solution of creating a times card voucher is provided, in which one secondary voucher of the created at least one secondary voucher corresponding to the times card can be subjected to one write-off, such that the write-off process may be more stable and orderly, thus improving accuracy of a write-off result.

In some optional implementations, after the primary voucher and the at least one secondary voucher corresponding to the times card are created based on the acquisition request, fund information allocated to each secondary voucher is determined and then recorded in the corresponding secondary voucher for a fund settlement of the merchant side, and thus it is not to calculate a settlement amount dynamically based on a fund pool during each write-off before performing the fund settlement. The fund information includes an actually-received amount of a merchant side, an actually-paid amount of a user side, and/or, a subsidy amount of a platform side in a case of use of a secondary voucher. For example, a user purchases a times card for purchasing chicken drumsticks three times (one for each time) using ten Yuan, and the actually-paid amount of the user side in the fund information of each secondary voucher is obtained as 10/3≈3.3 by performing averaging and then recorded in the three secondary vouchers. It is noted that the specific implementation is not limited to the averaging manner illustrated above. Optionally, a fund may be allocated to respective secondary vouchers based on a preset ratio. For example, as illustrated above, if the allocation is performed based on a ratio of 1:1:3, the actually-paid amounts of the user side recorded in the three secondary vouchers may be 2 Yuan, 2 Yuan and 6 Yuan respectively.

In some optional implementations, before the first write-off code corresponding to the primary voucher or the second write-off code corresponding to the at least one secondary voucher is generated, a write-off manner of the times card voucher is determined. The write-off manner includes writing off based on the first write-off code or writing off based on the second write-off code. By determining the write-off manner of the times card voucher, a risk that the times card voucher is used fraudulently is reduced. Specifically, the write-off manner of the times card voucher is determined based mainly on the following considerations: reputation of a shop, scale of a shop, value of a merchandise or service, and/or a write-off manner desired by a shop. If a shop has a higher reputation or a larger scale, it indicates that the shop is more trustable and has an extremely low possibility of using the write-off code fraudulently. In this case, the write-off may be performed using a fixed code, i.e. based on the first write-off code. On the contrary, if a shop has a lower reputation, or a smaller scale, it indicates that the shop needs to be improved in trustability and has a high possibility of using the write-off code fraudulently. In this case, fraudulent use may be avoided by performing write-off using a variable code. If a value of merchandise or a service included in the times card is high, a large loss may be brought to a user in a case of fraudulent use. In this case, the write-off may be performed using a variable code. Conversely, if a value of merchandise or a service included in the times card is low, the write-off may be performed using a fixed code.

Furthermore, in order to satisfy write-off requirements of different write-off manners, when the write-off manner of the times card voucher is determined as writing off based on the first write-off code, the first write-off code corresponding to the primary voucher is generated, where the first write-off code is a fixed code which may be used for several write-offs. For example, after one primary voucher and three secondary vouchers are created, the first write-off code corresponding to the primary voucher is generated. The first write-off code may be used for three write-offs, and one secondary voucher is written off in each write-off, where the first write-off code is always unchanged during the three write-offs. Alternatively, when the write-off manner of the times card voucher is determined as writing off based on the second write-off code, the second write-off code corresponding to the at least one secondary voucher is generated, where the second write-off code for each write-off is changeable.

Generation of a changeable second write-off code is described below.

Specifically, when the write-off manner is determined as writing off based on the second write-off code, one or more un-written-off secondary vouchers are determined from the at least one secondary voucher based on a write-off state of the at least one secondary voucher; one secondary voucher is selected from the un-written-off secondary vouchers as a to-be-written-off secondary voucher; and then, a second write-off code corresponding to the to-be-written-off secondary voucher is generated. The write-off state of each secondary voucher in the at least one secondary voucher may be updated continuously along with progress of the write-off. Those un-written-off secondary vouchers may change, and correspondingly, the selected to-be-written-off secondary voucher and the generated second write-off code corresponding to the to-be-written-off secondary voucher may change along. Thus, by generating the second write-off code corresponding to the to-be-written-off secondary voucher, a variable code write-off may be facilitated, thus reducing a risk that the write-off code is used fraudulently.

Furthermore, after the at least one secondary voucher is created or each time a write-off is completed for the to-be-written-off secondary voucher, the one or more un-written-off secondary vouchers are determined based on the write-off state of the at least one secondary voucher. In other words, after the at least one secondary voucher is created or each time one write-off is completed, one or more current un-written-off secondary vouchers are determined, and thus a new second write-off code is generated based on current write-off progress to write off the un-written-off secondary vouchers.

Furthermore, if there are plurality of un-written off secondary vouchers, a to-be-written-off secondary voucher may be selected in the following manner to avoid repetitive selection or omission of the to-be-written-off secondary voucher. In a first manner, one secondary voucher is selected from the un-written-off secondary vouchers as a to-be-written-off secondary voucher according to voucher identifiers of the un-written-off secondary vouchers. Optionally, the selection may be performed in a forward or reverse sequence of voucher identifiers, for example, in an ascending sequence of serial numbers. In a second manner, one secondary voucher is selected from the un-written-off secondary vouchers as a to-be-written-off secondary voucher according to fund information recorded in the un-written-off secondary vouchers. Optionally, the selection may be performed according to a size of influence of fund information for promoting consumption of users, such that secondary vouchers to which the fund information having larger influence for promoting consumption of users belongs are post-selected to attract users to use the remaining number of times. For example, the higher the platform subsidy amount is, the larger the influence for promoting consumption of users is. Therefore, the secondary vouchers with lower subsidy amounts are pre-selected and the secondary vouchers with higher subsidy amounts are post-selected.

In some optional implementations, after at least one of the first write-off code corresponding to the primary voucher or the second write-off code corresponding to the at least one secondary voucher is generated, the first write-off code or the second write-code is sent to a user side, such that the user side provides the first write-off code or the second write-code to a merchant side for writing off the at least one secondary voucher. After the first write-off code or the second write-off code is sent to and received by the user side, when there is a need for the user to consume merchandise or a service included in the times card, the user may provide the first write-off code or the second write-off code to the merchant side, and the merchant side may initiate a write-off request upon acquiring the first write-off code or the second write-off code, where the merchant side refers to a device for acquiring a write-off code from the user side in a shop where the times card can be used. For example, a scanning gun may initiate the write-off request by scanning a first write-off code displayed on the user side.

FIG. 2 is a flowchart illustrating a method of writing off a times card voucher according to an embodiment of the present disclosure. The method is performed by a voucher system of an online platform. As shown in FIG. 2, the method includes the following steps.

At step S201, according to a write-off request for at least one secondary voucher of a times card, a write-off code carried in the write-off request is analysed. The write-off code is a first write-off code corresponding to a primary voucher of the times card or a second write-off code corresponding to one secondary voucher of the at least one secondary voucher of the times card.

A number of the at least one secondary voucher is consistent with a number of times of use authorized for the times card. The write-off request for the at least one secondary voucher of the times card includes a write-off request for the at least one secondary voucher of the times card initiated by acquiring a write-off code from a user side by a merchant side. For example, a scanning gun may initiate a write-off request by scanning a write-off code.

After the user side acquires a times card, the user side may exchange for corresponding merchandise or services using the times card. In each use, a write-off is to be performed to update the remaining number of times of the times card.

In the present disclosure, one un-written-off secondary voucher is written off every time a write-off request is received. Further, when one secondary voucher is written off, the remaining number of times of the times card is decreased by 1. Specifically, a write-off request is received, where the write-off request may be initiated by acquiring a write-off code, for example, by inputting an identifier code or scanning a two-dimensional code and the like; a write-off code carried in the write-off request is analysed to determine a primary voucher or secondary voucher pointed to by the write-off code, and thus accurately determine a unique to-be-written-off secondary voucher for this write-off. The write-off code carried in the write-off request may be a first write-off code corresponding to the primary voucher or a second write-off code corresponding to one secondary voucher of the at least one secondary voucher, and a type of the write-off code (the first write-off code or the second write-off code) carried in the write-off request is determined and generated by a voucher system of an online platform.

At step S202, a to-be-written-off secondary voucher is selected from the at least one secondary voucher corresponding to the times card based on an analysis result to write off the to-be-written-off secondary voucher.

Specifically, after the primary voucher pointed to by the write-off code is determined through analysis, a to-be-written-off secondary voucher is selected based on a correspondence between the primary voucher and the at least one secondary voucher, where there is a correspondence between the primary voucher and the at least one secondary voucher of a same times card. Alternatively, after a secondary voucher pointed to by the write-off code is determined through analysis, a to-be-written-off secondary voucher is selected directly based on the secondary voucher. Next, the to-be-written-off secondary voucher is written off. In each write-off, the write-off is performed for one secondary voucher rather than for a same voucher.

For example, if the write-off code is a two-dimensional code corresponding to the primary voucher, a particular device may initiate a write-off request by scanning the two-dimensional code, analyse the two-dimensional code carried in the write-off request and select one secondary voucher from the at least one secondary voucher of a same times card. After the write-off, the number of the un-written-off secondary vouchers is decreased by 1 and the number of times of use authorized for the times card is also decreased by 1.

In the method of writing off a times card voucher according to this embodiment, every time a write-off request is received, a write-off is performed for one secondary voucher of the at least one secondary voucher based on a write-off code carried in the write-off request rather than for the created unique voucher. In the manner in which a write-off is performed for the unique voucher each time in the prior art, there is a problem that the unique voucher is preempted. In this embodiment, one secondary voucher is written off for each write-off, such that the write-off process becomes more stable and orderly, thus improving the accuracy of the write-off result.

In some optional implements, after the to-be-written-off secondary voucher is written off, a fund settlement on a merchant side is performed based on fund information recorded in the to-be-written-off secondary voucher. In the prior art, only one electronic voucher is generated, and it is to perform dynamic calculation based on a fund pool during each write-off, leading to complex allocation logic and bringing inconvenience to a strategy of payment adjustment. In these embodiments of the present disclosure, those funds paid to or refunded from a merchant side are all pre-allocated after each write-off, and hence the above problem of the prior art can be solved, making the fund allocation simple and controllable. Here, the following descriptions are made by still referring to the example in which a user purchases a times card for purchasing chicken drumsticks three times (one for each time) using ten Yuan. If there is no platform subsidy, an actually-received amount of a merchant side is an actually-paid amount of a user side. In the prior art, when payment is made to the merchant side for the first write-off, the actually-received amount of the merchant side is calculated as 10/3≈3.3; when payment is made to the merchant side for the second write-off, the actually-received amount of the merchant side is re-calculated as (10−3.3)/2≈3.4 Yuan; when payment is made to the merchant side for the third write-off, the actually-received amount of the merchant side is re-calculated as (10−3.3−3.4)/1=3.3 Yuan. However, in the technical solution of the present disclosure, the actually-received amount of the merchant side of each secondary voucher may be pre-calculated and recorded in the secondary voucher, such that a fund settlement can be performed on the merchant side directly based on the recorded actually-received amount of the merchant side during a write-off.

In the present disclosure, the write-off code carried in the write-off request may be the first write-off code or the second write-off code. A specific write-off process will be described below for the two cases.

In case 1, the write-off code is the first write-off code corresponding to the primary voucher of the times card.

In this case, the first write-off code is analysed to determine at least one secondary voucher associated with the primary voucher corresponding to the first write-off code, where the at least one secondary voucher associated with the primary voucher is a secondary voucher corresponding to a same times card. One or more un-written-off secondary vouchers are determined from the at least one secondary voucher based on a write-off state of the at least one secondary voucher, where the write-off state of the at least one secondary voucher may be recorded in the primary voucher or in the corresponding secondary voucher, for example, the write-off state of each associated secondary voucher is recorded as “written off” or “usable” in the primary voucher. One secondary voucher is selected from the un-written-off secondary vouchers as a to-be-written-off secondary voucher to write off the to-be-written-off secondary voucher. Generally, any one of the un-written-off secondary vouchers may be used for a current write-off, and thus a to-be-written-off secondary voucher may be selected therefrom for the write-off, which is different from the secondary voucher written off in the previous write-off. Correspondingly, even if there are a plurality of successive or parallel write-off requests, there may be no problem of failure to preemptively lock a same voucher in a write-off. In this case, the write-off process may be more stable and orderly. Furthermore, selecting one secondary voucher from the un-written-off secondary vouchers as a to-be-written-off secondary voucher includes: selecting one secondary voucher from the un-written-off secondary vouchers as a to-be-written-off secondary voucher based on voucher identifiers of the un-written-off secondary vouchers; or, selecting one secondary voucher from the un-written-off secondary vouchers as a to-be-written-off secondary voucher based on fund information recorded in the un-written-off secondary vouchers.

In case 2, the write-off code is the second write-off code corresponding to one secondary voucher of the at least one secondary voucher of the times card.

In this case, the second write-off code is analysed to determine a secondary voucher corresponding to the second write-off code; the secondary voucher corresponding to the second write-off code is selected as a to-be-written-off secondary voucher to write off the to-be-written-off secondary voucher.

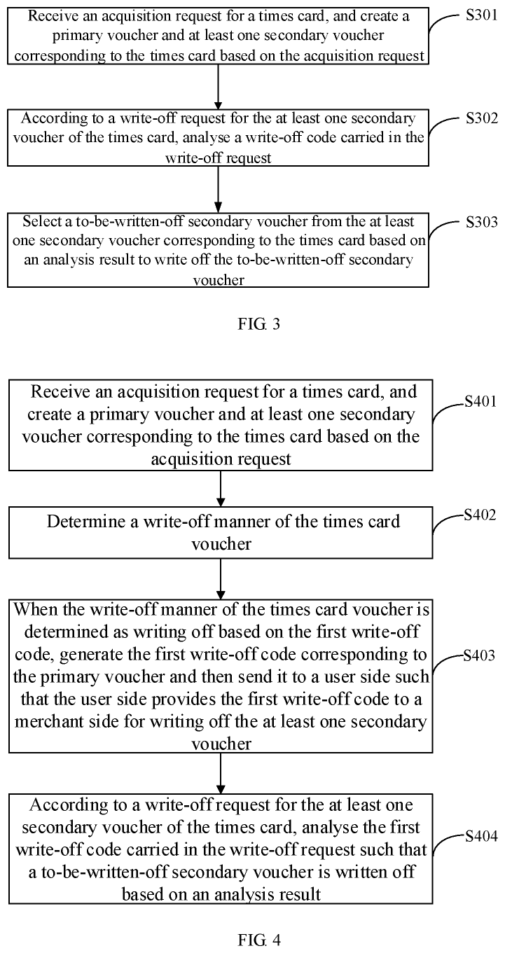

FIG. 3 is a flowchart illustrating a method of writing off a times card voucher according to another embodiment of the present disclosure. The method is performed by a voucher system of an online platform. As shown in FIG. 3, the method includes the following steps.

At step S301, an acquisition request for a times card is received, and a primary voucher and at least one secondary voucher corresponding to the times card are created based on the acquisition request.

A number of the at least one secondary voucher is consistent with a number of times of use authorized for the times card.

At step S302, according to a write-off request for the at least one secondary voucher of the times card, a write-off code carried in the write-off request is analysed.

After acquiring a times card, the user side may exchange for corresponding merchandise or services using the times card. In each use, a write-off is to be performed to update the remaining number of times of the times card.

In the present disclosure, one un-written-off secondary voucher is written off every time a write-off request is received. Further, when one secondary voucher is written off, the remaining number of times of the times card is decreased by 1. Specifically, a write-off request is received, where the write-off request may be initiated by acquiring a write-off code, for example, by inputting an identifier code or scanning a two-dimensional code and the like; a write-off code carried in the write-off request is analysed to determine a primary voucher or secondary voucher pointed to by the write-off code, and thus accurately determine a unique to-be-written-off secondary voucher for this write-off. The write-off code carried in the write-off request may be a first write-off code corresponding to the primary voucher or a second write-off code corresponding to one secondary voucher of the at least one secondary voucher, and a type of the write-off code (the first write-off code or the second write-off code) carried in the write-off request is determined and generated by a voucher system of an online platform.

At step S303, a to-be-written-off secondary voucher is selected from the at least one secondary voucher corresponding to the times card based on an analysis result to write off the to-be-written-off secondary voucher.

Specifically, after the primary voucher pointed to by the write-off code is determined through analysis, a to-be-written-off secondary voucher is selected based on a correspondence between the primary voucher and the at least one secondary voucher, where there is a correspondence between the primary voucher and the at least one secondary voucher of a same times card. Alternatively, after a secondary voucher pointed to by the write-off code is determined through analysis, a to-be-written-off secondary voucher is selected directly based on the secondary voucher. Next, the to-be-written-off secondary voucher is written off. In each write-off, the write-off is performed for one secondary voucher rather than for a same voucher.

In the method of writing off a times card voucher according to this embodiment, when an acquisition request for a times card is received, a primary voucher and at least one secondary voucher corresponding to the times card are created rather than only creating one unique voucher; every time a write-off request is received, a write-off can be performed for the at least one secondary voucher rather than for the created unique voucher, based on the write-off code carried in the write-off request. Therefore, the embodiment provides an all-new solution of writing off a times card voucher, in which one secondary voucher of the at least one secondary voucher created corresponding to the times card can be subjected to one write-off. In the prior art, a write-off is performed for the unique voucher each time, leading to a problem of preemption of the unique voucher; in the technical solution of the present disclosure, a write-off is performed for one secondary voucher in each write-off, such that the write-off process is more stable and orderly, improving the accuracy of the write-off result.

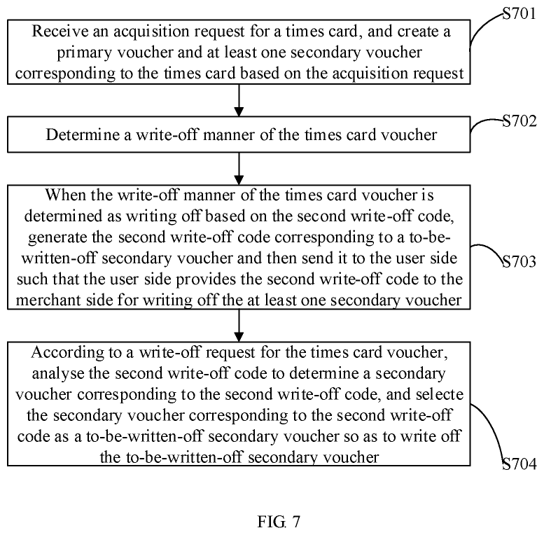

Before the following method embodiment of the present disclosure is carried out, it is noted that actually, there may be different requirements for risk of fraudulent use of the times card due to different shops or different merchandise or services. In the following embodiment, a permissible write-off manner is determined for a different times card. For example, for a shop with good reputation, a merchant has a low possibility of fraudulently using a write-off code of a times card voucher for write-off, and therefore, a times card issued by such shops may be written off using a fixed code (corresponding to the embodiment of FIG. 4, that is, the write-off code is always the first write-off code); conversely, for a shop with poor reputation, a times card issued by such shops is to be written off using a variable code (corresponding to the embodiment of FIG. 7, that is, the write-off code is a different second write-off code) so as to avoid fraudulent use of the times card by the merchant. In other words, write-off codes carried in different write-off requests are different. The following descriptions are made below by referring to a fixed code write-off (corresponding to writing off based on the first write-off code in FIG. 4) and a variable code write-off (corresponding to writing off based on the second write-off code in FIG. 7).

FIG. 4 is a flowchart illustrating a method of writing off a times card voucher according to another embodiment of the present disclosure. The method is performed by a voucher system of an online platform. In this embodiment, descriptions are mainly made to writing off based on a first write-off code. As shown in FIG. 4, the method includes the following steps.

At step S401, an acquisition request for a times card is received, and a primary voucher and at least one secondary voucher corresponding to the times card are created based on the acquisition request.

In an optional implementation of the present disclosure, after the vouchers are created, fund information allocated to each secondary voucher is determined; the fund information is then recorded in the corresponding secondary voucher so as to perform direct fund settlement based on the fund information without needing to perform the settlement after calculating a settlement amount dynamically based on a fund pool during each write-off. The fund information includes an actually-received amount of a merchant side, an actually-paid amount of a user side, and/or, a subsidy amount of a platform side in a case of use of a secondary voucher.

FIG. 5 is a schematic diagram of creating a times card voucher according to a specific embodiment. As shown in FIG. 5, after a user purchases a times card by placing an order on a user side, an electronic voucher system of an online platform creates electronic vouchers to obtain one primary voucher and four secondary vouchers corresponding to the times card. In this case, a secondary voucher is selected from the four secondary vouchers for writing off during each write-off.

At step S402, a write-off manner of the times card voucher is determined.

The write-off manner includes writing off based on a first write-off code or writing off based on a second write-off code. When a write-off is performed based on the first write-off code, the write-off is performed using the first write-off code corresponding to the primary voucher each time, where the write-off code is a fixed code; when the write-off is performed based on the second write-off code, the write-off is performed using the second write-off code corresponding to a different secondary voucher each time, where the write-off code is a variable code.

After a voucher corresponding to the times card is created, the write-off manner of the times card voucher is determined to reduce a risk of fraudulent use of the times card voucher. Specifically, the write-off manner of the times card voucher is determined based mainly on the following considerations: reputation of shop, scale of shop, value of merchandise or service, and/or write-off manner desired by shop.

At step S403, when the write-off manner of the times card voucher is determined as writing off based on the first write-off code, the first write-off code corresponding to the primary voucher is generated and then sent to a user side such that the user side provides the first write-off code to a merchant side for writing off the at least one secondary voucher.

Specifically, when the write-off manner of the times card voucher is determined as writing off based on the first write-off code, the first write-off code corresponding to the primary voucher is generated by a voucher system and then provided to the merchant side to initiate a write-off request, for example, initiate the write-off request by scanning the first write-off code using a scanning gun. In an embodiment in which a write-off is performed based on the first write-off code, it is only to generate one second write-off code and send it to the user side. In subsequent several write-offs, the write-off requests are all initiated using the first write-off code.

At step S404, according to a write-off request for the at least one secondary voucher of the times card, the first write-off code carried in the write-off request is analysed such that a to-be-written-off secondary voucher is written off based on an analysis result.

When the user side receives the first write-off code, a user may provide the first write-off code to the merchant side in a case of in need of merchandise or a service included in the times card, and the merchant side initiates a write-off request upon acquiring the first write-off code. The merchant side here refers to a device for acquiring a write-off code from the user side in a shop where the times card can be used, for example, a scanning gun.

Specifically, a write-off request initiated by acquiring the first write-off code is received, and the first write-off code carried in the write-off request is analysed to determine at least one secondary voucher associated with the primary voucher corresponding to the first write-off code, where a times card for this write-off is determined by analysing the first write-off code and the at least one secondary voucher associated with the primary voucher is a secondary voucher corresponding to a same times card. One or more un-written-off secondary vouchers are determined from the at least one secondary voucher based on a write-off state of the at least one secondary voucher, where the write-off state of the at least one secondary voucher may be recorded in the primary voucher or in the corresponding secondary voucher, for example, the write-off state of each associated secondary voucher is recorded as “written off” or “usable” in the primary voucher. One secondary voucher is selected from the un-written-off secondary vouchers as a to-be-written-off secondary voucher to write off the to-be-written-off secondary voucher. Generally, any one of the un-written-off secondary vouchers may be used for a current write-off, and thus a to-be-written-off secondary voucher may be selected therefrom for the write-off, which is different from the secondary voucher written off in the previous write-off. Correspondingly, even if there are a plurality of successive or parallel write-off requests, there will be no problem of failure to preemptively lock a same voucher in a write-off. In this case, the write-off process will be more stable and orderly.

Furthermore, selecting one secondary voucher from the un-written-off secondary vouchers as a to-be-written-off secondary voucher is performed as follows: one secondary voucher is selected from the un-written-off secondary vouchers as a to-be-written-off secondary voucher according to voucher identifiers of the un-written-off secondary vouchers, and optionally, the selection may be performed in a forward or reverse sequence of voucher identifiers, for example, in an ascending sequence of serial numbers; alternatively, one secondary voucher is selected from the un-written-off secondary vouchers as a to-be-written-off secondary voucher according to fund information recorded in the un-written-off secondary vouchers, and optionally, the selection may be performed according to a size of influence of fund information for promoting consumption of users, such that secondary vouchers to which the fund information having larger influence for promoting consumption of users belongs are post-selected to attract users to use the remaining number of times. For example, the higher the platform subsidy amount is, the larger the influence for promoting consumption of users is. Therefore, the secondary vouchers with lower subsidy amounts are pre-selected and the secondary vouchers with higher subsidy amounts are post-selected.

Furthermore, in an embodiment where fund information is recorded in the secondary voucher, after the to-be-written-off secondary voucher is written off, a fund settlement on the merchant side is performed based on the fund information. In the prior art, only one electronic voucher is generated, and it is to perform dynamic calculation based on a fund pool during each write-off, leading to complex allocation logic and bringing inconvenience to a strategy of payment adjustment. In these embodiments of the present disclosure, those funds paid to or refunded from a merchant side are all pre-allocated after each write-off, and hence the above problem of the prior art can be solved, making the fund allocation simple and controllable.

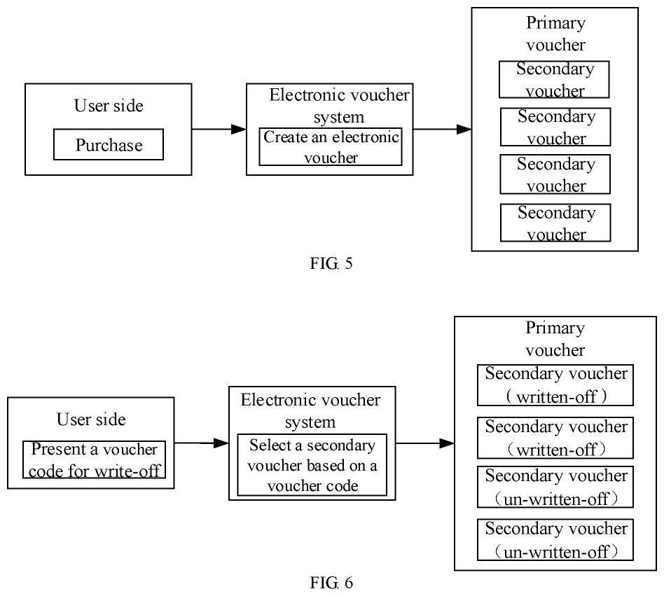

FIG. 6 is a schematic diagram of selecting a secondary voucher for write-off according to a specific embodiment. As shown in FIG. 6, when the write-off is performed based on the first write-off code which is a voucher code presented by a user side in FIG. 6, the electronic voucher system recognizes the first write-off code, determines two available secondary vouchers (un-written-off) are present, and then selects a to-be-written-off secondary voucher from the two secondary vouchers for write-off.

In the method of writing off a times card voucher according to this embodiment, when an acquisition request for a times card is received, a primary voucher and at least one secondary voucher corresponding to the times card are created rather than only creating one unique voucher; a write-off manner of the times card voucher is determined, and for a times card voucher to be written off based on the first write-off code, the first write-off code corresponding to the primary voucher is generated for write-off; during the write-off, the first write-off code carried in the write-off request is analysed to write off an un-written-off secondary voucher selected from the at least one secondary voucher associated with the primary voucher. In the solution of this embodiment, the write-off is performed using the fixed code, that is, multiple write-offs are performed using one code; each write-off is performed for one un-written-off secondary voucher, such that failure to preemptively lock in a parallel scenario arising from generation of a single voucher is avoided based on an exclusive lock of the corresponding secondary voucher and the write-off process will become more stable and orderly, thus improving the accuracy of the write-off result. In addition, after the secondary vouchers are created, a fund is calculated and pre-allocated to each secondary voucher, and a fund settlement is performed based on the fund during the write-off, thereby simplifying the fund allocation logic, increasing controllability, and facilitating adjustment of payment strategy.

FIG. 7 is a flowchart of a method of writing off a times card voucher according to yet another embodiment of the present disclosure. The method is performed by a voucher system of an online platform. In this embodiment, descriptions are mainly made to writing off based on a second write-off code. As shown in FIG. 7, the method includes the following steps.

At step S701, an acquisition request for a times card is received, and a primary voucher and at least one secondary voucher corresponding to the times card are created based on the acquisition request.

A number of the at least one secondary voucher is consistent with a number of times of use authorized for the times card.

In an optional implementation of the present disclosure, after vouchers are created, fund information allocated to each secondary voucher is determined; the fund information is recorded in the corresponding secondary voucher such that direct fund settlement is performed based on the fund information without needing to perform dynamic calculation based on a fund pool before the fund settlement after each write-off

At step S702, a write-off manner of the times card voucher is determined.

The write-off manner includes writing off based on the first write-off code, or writing off based on the second write-off code.

The implementation principle and process of the above steps S701 and S702 correspond to the steps S401 and S402 shown in FIG. 4. Therefore, reference may be made to the descriptions of the steps S401 and S402 for details and redundant descriptions will not be made herein.

At step S703, when the write-off manner of the times card voucher is determined as writing off based on the second write-off code, the second write-off code corresponding to a to-be-written-off secondary voucher is generated and then sent to the user side such that the user side provides the second write-off code to the merchant side for writing off the at least one secondary voucher.

Specifically, after the at least one secondary voucher is created or each time a write-off is completed for the to-be-written-off secondary voucher, the one or more un-written-off secondary vouchers are determined based on a write-off state of the at least one secondary voucher; one secondary voucher is selected from the un-written-off secondary vouchers as a to-be-written-off secondary voucher. Selecting one secondary voucher from the un-written-off secondary vouchers includes: selecting one secondary voucher from the un-written-off secondary vouchers as a to-be-written-off secondary voucher according to voucher identifiers of the un-written-off secondary vouchers; or, selecting one secondary voucher from the un-written-off secondary vouchers as a to-be-written-off secondary voucher according to fund information recorded in the un-written-off secondary vouchers. The above principle and process in which one secondary voucher is selected are similar to the selection process of the step S404 in the embodiment corresponding to FIG. 4. Therefore, reference may be made to the descriptions of the step S404 for details and redundant descriptions will not be made herein.

Furthermore, different from the embodiment corresponding to FIG. 4, in this embodiment, a second write-off code corresponding to one secondary voucher is generated and then sent to the user side such that the user side provides the second write-off code to the merchant side for writing off the at least one secondary voucher. In other words, in this embodiment, the write-off code presented by the user for a write-off is the second write-off code, and the second write-off code presented for each write-off is a write-off code corresponding to the to-be-written-off secondary voucher selected this time. In this way, a variable code write-off is achieved and fraudulent use of the times card voucher by the merchant is avoided.

In step S703, after a write-off is performed each time or the at least one secondary voucher is created, one secondary voucher is selected and a second write-off code corresponding to the one secondary voucher is generated for next write-off. In this way, code changing capability is provided to solve a risk of fraudulent use arising from inability to change code.

At step S704, according to a write-off request for the times card voucher, the second write-off code is analysed to determine a secondary voucher corresponding to the second write-off code, and the secondary voucher corresponding to the second write-off code is selected as a to-be-written-off secondary voucher so as to write off the to-be-written-off secondary voucher.

When the write-off manner of the times card voucher is determined as writing off based on the second write-off code, that is, a variable code write-off is to be performed, the second write-off code carried in the write-off request is analysed to write off a corresponding secondary voucher. The second write-off code is a write-off code corresponding to one secondary voucher selected after a previous write-off is completed or the at least one secondary voucher is created.

Specifically, a write-off request initiated by acquiring the second write-off code is received, the second write-off code is analysed to determine a to-be-written-off secondary voucher corresponding to the second write-off code, and a write-off is performed for the to-be-written-off secondary voucher. The second write-off code is a write-off code corresponding to the to-be-written-off secondary voucher, and thus the to-be-written-off secondary voucher can be directly determined and written off by analysing the second write-off code.

In addition, in an embodiment where fund information is recorded in the secondary voucher, after the at least one secondary voucher is written off, a fund settlement on the merchant side is performed based on the fund information. For the specific descriptions of the fund settlement, reference may be made to descriptions at corresponding position of step S404 in the embodiment corresponding to FIG. 4 and thus redundant descriptions will not be made herein.

Still taking FIG. 6 as an example, when the write-off is performed based on the second write-off code, a voucher code presented by a user side in FIG. 6 is the second write-off code corresponding to a to-be-written-off secondary voucher, and the electronic voucher system recognizes the second write-off code, determines the to-be-written-off secondary voucher (one of two available secondary vouchers in FIG. 6) and performs the write-off.

In the method of writing off a times card voucher according to this embodiment, when an acquisition request for a times card is received, a primary voucher and at least one secondary voucher corresponding to the times card are created rather than only creating one unique voucher; a write-off manner of the times card voucher is determined, and for a times card voucher to be written off based on the second write-off code, after each write-off is completed or the at least one secondary voucher is created, one secondary voucher is selected as a to-be-written-off secondary voucher and a second write-off code corresponding to the to-be-written-off secondary voucher is generated for write-off; during a write-off, the second write-off code carried in the write-off request is analysed to write off the to-be-written-off secondary voucher. In the technical solution of this embodiment, code changing capability can be provided to perform the write-off using a variable code, thus solving the risk of fraudulent use arising from inability to change code, and improving use experiences of the users. Further, each write-off or payment is always made for one un-written-off secondary voucher, such that failure to preemptively lock in a parallel scenario arising from generation of a single voucher is avoided based on an exclusive lock of the corresponding secondary voucher, and the write-off process will become more stable and orderly, thus improving the accuracy of the write-off result. In addition, after the secondary vouchers are created, fund is calculated and pre-allocated to each secondary voucher, and payment is made based on the fund during the write-off, thereby simplifying fund allocation logic, increasing controllability and facilitating adjustment of payment strategy.

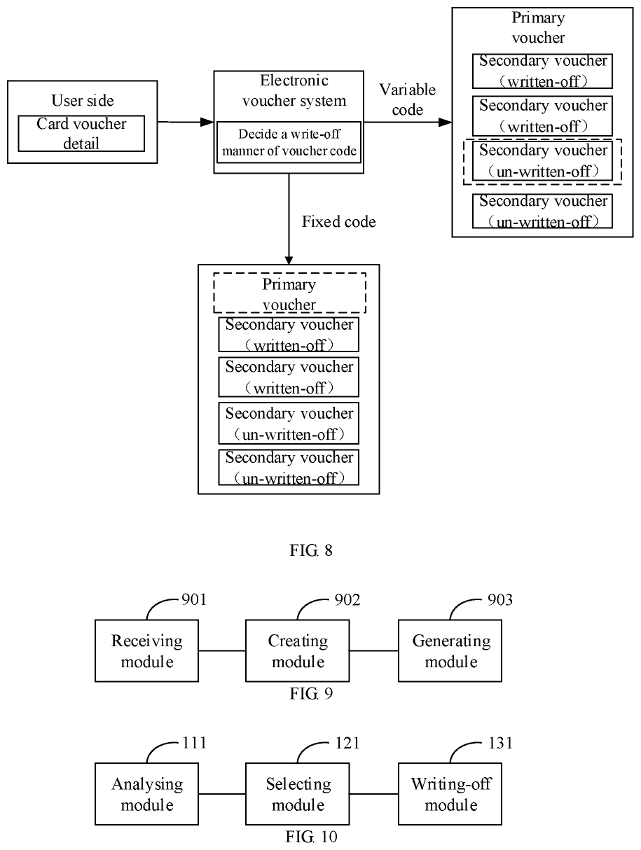

It is noted that although the write-off manners of fixed code and variable code are described separately as above, there may be possibility of switching the write-off manners for a same times card in an actual implementation process. For example, a shop may switch the write-off manner from fixed code write-off to variable code write-off during a business adjustment period. Based on this consideration, in some other embodiments of the present disclosure, decision is made to generate the first write-off code or the second write-off code for a write-off every time it is detected that the write-off manner is updated. FIG. 8 is a schematic diagram illustrating a fixed code or variable code displayed by a user side according to a specific embodiment of the present disclosure. As shown in FIG. 8, the electronic voucher system may determine a write-off manner based on details of a times card. If there is no need to change code, that is, the write-off is performed based on the first write-off code, the first write-off code (fixed code) corresponding to the primary voucher is displayed on the user side; if there is a need to change code, that is, the write-off is performed based on the second write-off code, a to-be-written-off secondary voucher is selected and the second write-off code (variable code) corresponding to the to-be-written-off secondary voucher is displayed on the user side.

FIG. 9 is functional block diagram illustrating an apparatus for creating a times card voucher according to an embodiment of the present disclosure. As shown in FIG. 9, the apparatus includes the following modules:

a receiving module 901, configured to receive an acquisition request for a times card; a creating module 902, configured to create a primary voucher and at least one secondary voucher corresponding to the times card based on the acquisition request, wherein a number of the at least one secondary voucher is consistent with a number of times of use authorized for the times card; and a generating module 903, configured to generate at least one of a first write-off code corresponding to the primary voucher, or a second write-off code corresponding to the at least one secondary voucher, so as to write off the at least one secondary voucher.

In an optional implementation, the apparatus further includes a recording module, configured to determine fund information allocated to each secondary voucher, and record the fund information in the corresponding secondary voucher for a fund settlement on a merchant side.

In an optional implementation, the apparatus further includes a determining module, configured to determine a write-off manner of the times card voucher, where the write-off manner includes writing off based on the first write-off code, or writing off based on the second write-off code. The generating module 903 is further configured to: when the write-off manner of the times card voucher is determined as writing off based on the first write-off code, generate the first write-off code corresponding to the primary voucher; or, when the write-off manner of the times card voucher is determined as writing off based on the second write-off code, generate the second write-off code corresponding to the at least one secondary voucher.

In an optional implementation, the apparatus further includes a selecting module, configured to determine, from the at least one secondary voucher, one or more un-written-off secondary vouchers based on a write-off state of at least one secondary voucher; and select one secondary voucher from the un-written-off secondary vouchers as a to-be-written-off secondary voucher. The generating module 903 is further configured to: generate the second write-off code corresponding to the to-be-written-off secondary voucher.

In an optional implementation, the selecting module is further configured to: after the at least one secondary voucher is created or each time a write-off is completed for the to-be-written-off secondary voucher, determine the one or more un-written-off secondary vouchers based on the write-off state of the at least one secondary voucher.

In an optional implementation, the selecting module is further configured to: select one secondary voucher from the un-written-off secondary vouchers as the to-be-written-off secondary voucher based on voucher identifiers of the un-written-off secondary vouchers; or, select one secondary voucher from the un-written-off secondary vouchers as the to-be-written-off secondary voucher based on fund information recorded in the un-written-off secondary vouchers.

In an optional implementation, the apparatus further includes a sending module, configured to send the first write-off code or the second write-off code to a user side such that the user side provides the first write-off code or the second write-off code to a merchant side for writing off the at least one secondary voucher.

FIG. 10 is a functional block diagram illustrating an apparatus for writing off a times card voucher according to an embodiment of the present disclosure. As shown in FIG. 10, the apparatus includes the following modules:

an analysing module 111, configured to, according to a write-off request for at least one secondary voucher of a times card, analyse a write-off code carried in the write-off request; wherein the write-off code is a first write-off code corresponding to a primary voucher of the times card, or a second write-off code corresponding to one secondary voucher of the at least one secondary voucher of the times card; and a number of the at least one secondary voucher is consistent with a number of times of use authorized for the times card; a selecting module 121, configured to select a to-be-written-off secondary voucher from the at least one secondary voucher corresponding to the times card based on an analysis result; and a writing-off module 131, configured to write off the to-be-written-off secondary voucher.

In an optional implementation, the apparatus further includes a settling module, configured to perform a fund settlement on a merchant side based on fund information recorded in the to-be-written-off secondary voucher.

In an optional implementation, the write-off request for the at least one secondary voucher of the times card includes: a write-off request for the at least one secondary voucher of the times card initiated by acquiring a write-off code from a user side by the merchant side.

In an optional implementation, when the write-off code is the first write-off code corresponding to the primary voucher of the times card, the analysing module 111 is further configured to analyse the first write-off code to determine the at least one secondary voucher associated with the primary voucher corresponding to the first write-off code; the selecting module 121 is further configured to: determine, from the at least one secondary voucher, one or more un-written-off secondary vouchers based on a write-off state of at least one secondary voucher; and select one secondary voucher from the un-written-off secondary vouchers as the to-be-written-off secondary voucher.

In an optional implementation, the selecting module 121 is further configured to: select one secondary voucher from the un-written-off secondary vouchers as the to-be-written-off secondary voucher based on voucher identifiers of the un-written-off secondary vouchers; or, select one secondary voucher from the un-written-off secondary vouchers as the to-be-written-off secondary voucher based on fund information recorded in the un-written-off secondary vouchers.

In an optional implementation, when the write-off code is the second write-off code corresponding to one secondary voucher of the at least one secondary voucher of the times card, the analysing module 111 is further configured to: analyse the second write-off code to determine a secondary voucher corresponding to the second write-off code; the selecting module 121 is further configure to: select the secondary voucher corresponding to the second write-off code as the to-be-written-off secondary voucher.

An embodiment of the present disclosure provides a system for writing off a times card voucher. The system includes the apparatus for creating a times card voucher according to any one of the above apparatus embodiments and the apparatus for writing off a times card voucher according to any one of the above apparatus embodiments.

An embodiment of the present disclosure provides a non-volatile computer readable storage medium, storing at least one executable instruction which causes a processor to perform the method of creating a times card voucher according to any one of the above method embodiments.

An embodiment of the present disclosure provides a non-volatile computer readable storage medium, storing at least one executable instruction which causes a processor to perform the method of writing off a times card voucher according to any one of the above method embodiments.

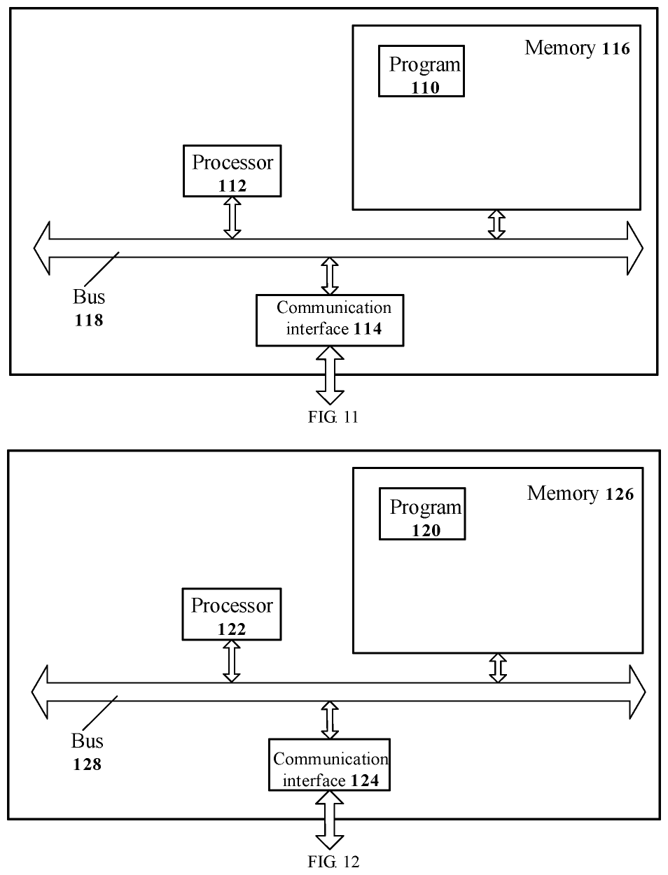

FIG. 11 is a structural schematic diagram illustrating a computing device according to an embodiment of the present disclosure. The specific embodiments of the present disclosure do not define the specific implementation of the computing device. As shown in FIG. 11, the computing device may include a processor 112, a communication interface 114, a memory 116, and a communication bus 118. The processor 112, the communication interface 114 and the memory 116 communicate with each other via the communication bus 118. The communication interface 114 is used to communicate with network elements, for example, other devices such as client, or other servers or the like. The processor 112 is used to execute a program 110 and may execute relevant steps in the above embodiments of the method of creating a times card voucher. Specifically, the program 110 may include program codes which include computer operation instructions. The processor 112 may be a central processing unit (CPU), or an Application Specific Integrated Circuit (ASIC), or one or more integrated circuits configured for implementing the embodiments of the present disclosure. The computing device includes one or more processors which may be of a same type, for example, one or more CPUs, or may be of different types, for example, one or more CPUs and one or more ASICs. The memory 116 is used to store program 110. The memory 116 may include a high-speed random access memory, or a non-volatile memory, for example, at least one disk memory.

The program 110 may be specifically used to enable the processor 112 to execute the following operations: receiving an acquisition request for a times card; creating a primary voucher and at least one secondary voucher corresponding to the times card based on the acquisition request, wherein a number of the at least one secondary voucher is consistent with a number of times of use authorized for the times card; and generating at least one of a first write-off code corresponding to the primary voucher, or a second write-off code corresponding to the at least one secondary voucher , so as to write off the at least one secondary voucher.

In an optional implementation, the program 110 may be further configured to enable the processor 112 to execute the following operations: determining fund information allocated to each secondary voucher; recording the fund information in the corresponding secondary voucher for a fund settlement of a merchant side.

In an optional implementation, the program 110 may be further configured to enable the processor 112 execute the following operations: determining a write-off manner of the times card voucher; wherein the write-off manner includes writing off based on the first write-off code, or writing off based on the second write-off code; when the write-off manner of the times card voucher is determined as writing off based on the first write-off code, generating the first write-off code corresponding to the primary voucher; or, when the write-off manner of the times card voucher is determined as writing off based on the second write-off code, generating the second write-off code corresponding to the at least one secondary voucher.

In an optional implementation, the program 110 may be further configured to enable the processor 112 execute the following operations: determining, from the at least one secondary voucher, one or more un-written-off secondary vouchers based on a write-off state of at least one secondary voucher; selecting one secondary voucher from the un-written-off secondary vouchers as a to-be-written-off secondary voucher; generating the second write-off code corresponding to the to-be-written-off secondary voucher.

In an optional implementation, the program 110 may be further configured to enable the processor 112 execute the following operations: after the at least one secondary voucher is created or each time a write-off is complete for the to-be-written-off secondary voucher, determining the one or more un-written-off secondary vouchers based on the write-off state of the at least one secondary voucher.

In an optional implementation, the program 110 may be further configured to enable the processor 112 execute the following operations: selecting one secondary voucher from the un-written-off secondary vouchers as the to-be-written-off secondary voucher based on voucher identifiers of the un-written-off secondary vouchers; or, selecting one secondary voucher from the un-written-off secondary vouchers as the to-be-written-off secondary voucher based on fund information recorded in the un-written-off secondary vouchers.

In an optional implementation, the program 110 may be further configured to enable the processor 112 execute the following operations: sending the first write-off code or the second write-off code to a user side such that the user side provides the first write-off code or the second write-off code to a merchant side for writing off the at least one secondary voucher.

FIG. 12 is a structural schematic diagram illustrating another computing device according to an embodiment of the present disclosure. The specific embodiments of the present disclosure do not define the specific implementation of the computing device. As shown in FIG. 12, the computing device may include a processor 122, a communication interface 124, a memory 126, and a communication bus 128. The processor 122, the communication interface 124 and the memory 126 communicate with each other via the communication bus 128. The communication interface 124 is used to communicate with network elements, for example, other devices such as client, or other servers or the like. The processor 122 is used to execute a program 120 and may execute relevant steps in the above embodiments of the method of writing off a times card voucher. Specifically, the program 120 may include program codes which include computer operation instructions. The processor 122 may be a central processing unit (CPU), or an Application Specific Integrated Circuit (ASIC), or one or more integrated circuits configured for implementing the embodiments of the present disclosure. The computing device includes one or more processors which may be of a same type, for example, one or more CPUs, or may be of different types, for example, one or more CPUs and one or more ASICs. The memory 126 is used to store program 120. The memory 126 may include a high-speed random access memory, or a non-volatile memory, for example, at least one disk memory.

The program 120 is configured to enable the processor 120 to execute the following operations: according to a write-off request for at least one secondary voucher of a times card, analysing a write-off code carried in the write-off request; wherein the write-off code is a first write-off code corresponding to a primary voucher of the times card or a second write-off code corresponding to one secondary voucher of the at least one secondary voucher of the times card; and a number of the at least one secondary voucher is consistent with a number of times of use authorized for the times card; selecting a to-be-written-off secondary voucher from the at least one secondary voucher corresponding to the times card based on an analysis result to write off the to-be-written-off secondary voucher.

In an optional implementation, the program 120 is further configured to enable the processor 122 to execute the following operations: performing a fund settlement on a merchant side according to fund information recorded in the to-be-written-off secondary voucher.

In an optional implementation, the program 120 is further configured to enable the processor 122 to execute the following operations: a write-off request for the at least one secondary voucher of the times card initiated by acquiring the write-off code from a user side by a merchant side.

In an optional implementation, the program 120 is further configured to enable the processor 122 to execute the following operations: analysing the first write-off code to determine the at least one secondary voucher associated with the primary voucher corresponding to the first write-off code; determining, from the at least one secondary voucher, one or more un-written-off secondary vouchers based on a write-off state of the at least one secondary voucher; selecting one secondary voucher from the un-written-off secondary vouchers as the to-be-written-off secondary voucher.

In an optional implementation, the program 120 is further configured to enable the processor 122 to execute the following operations: selecting one secondary voucher from the un-written-off secondary vouchers as the to-be-written-off secondary voucher based on voucher identifiers of the un-written-off secondary vouchers; or, selecting one secondary voucher from the un-written-off secondary vouchers as the to-be-written-off secondary voucher based on fund information recorded in the un-written-off secondary vouchers.

In an optional implementation, the program 120 is further configured to enable the processor 122 to execute the following operations: analysing the second write-off code to determine a secondary voucher corresponding to the second write-off code; selecting the secondary voucher corresponding to the second write-off code as the to-be-written-off secondary voucher.

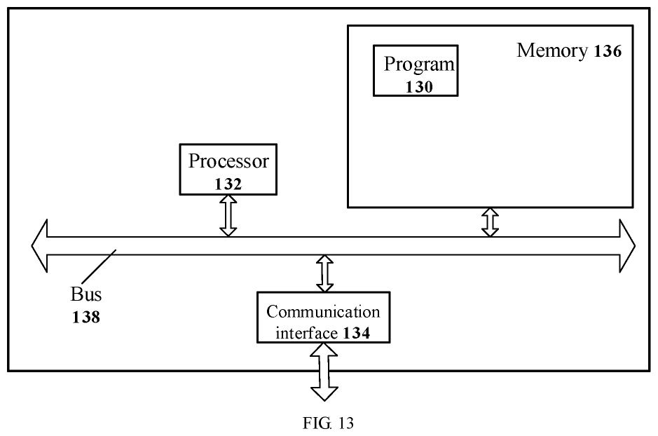

FIG. 13 is a structural schematic diagram illustrating yet another computing device according to an embodiment of the present disclosure. The specific embodiments of the present disclosure do not define the specific implementation of the computing device. As shown in FIG. 13, the computing device may include a processor 132, a communication interface 134, a memory 136, and a communication bus 138. The processor 132, the communication interface 134 and the memory 136 communicate with each other via the communication bus 138. The communication interface 134 is used to communicate with network elements, for example, other devices such as client, or other servers or the like. The processor 132 is used to execute a program 130 and may execute relevant steps in the above embodiments of the method of writing off a times card voucher. Specifically, the program 130 may include program codes which include computer operation instructions. The processor 132 may be a central processing unit (CPU), or an Application Specific Integrated Circuit (ASIC), or one or more integrated circuits configured for implementing the embodiments of the present disclosure. The computing device includes one or more processors which may be of a same type, for example, one or more CPUs, or may be of different types, for example, one or more CPUs and one or more ASICs. The memory 136 is used to store program 130. The memory 136 may include a high-speed random access memory, or a non-volatile memory, for example, at least one disk memory.

The program 130 is configured to enable the processor 132 to execute the following operations: receiving an acquisition request for a times card; creating a primary voucher and at least one secondary voucher corresponding to the times card based on the acquisition request, wherein a number of the at least one secondary voucher is consistent with a number of times of use authorized for the times card; according to a write-off request for the at least one secondary voucher of the times card, analysing a write-off code carried in the write-off request, where the write-off code is a first write-off code corresponding to the primary voucher, or a second write-off code corresponding to one secondary voucher; and selecting a to-be-written-off secondary voucher from the at least one secondary voucher corresponding to the times card based on an analysis result to write off the to-be-written-off secondary voucher.

In an optional implementation, the program 130 is further configured to enable the processor 132 to execute the following operations: determining fund information allocated to each secondary voucher; recording the fund information in the corresponding secondary voucher; and after writing off the to-be-written-off secondary voucher, performing a fund settlement on a merchant side based on the fund information.

In an optional implementation, the program 130 is further configured to enable the processor 132 to execute the following operations: determining a write-off manner of the times card voucher; wherein the write-off manner comprises writing off based on the first write-off code or writing off based on the second write-off code.

In an optional implementation, the program 130 is further configured to enable the processor 132 to execute the following operations: generating the first write-off code corresponding to the primary voucher and sending the first write-off code to a user side such that the user side provides the first write-off code to the merchant side for writing off the at least one secondary voucher; analysing the first write-off code carried in the write-off request and determining the at least one secondary voucher associated with the primary voucher corresponding to the first write-off code; determining, from the at least one secondary voucher, one or more un-written-off secondary vouchers based on a write-off state of the at least one secondary voucher; and selecting one secondary voucher from the un-written-off secondary vouchers as the to-be-written-off secondary voucher.

In an optional implementation, the program 130 is specifically further configured to enable the processor 132 to execute the following operations: after the at least one secondary voucher is created or each time a write-off is completed for the to-be-written-off secondary voucher, determining the one or more un-written-off secondary vouchers based on the write-off state of the at least one secondary voucher; selecting one secondary voucher from the un-written-off secondary vouchers; and generating the second write-off code corresponding to the one secondary voucher and sending the second write-off code to a user side such that the user side provides the second write-off code to the merchant side for writing off the at least one secondary voucher; analysing the second write-off code to determine a secondary voucher corresponding to the second write-off code; selecting a secondary voucher corresponding to the second write-off code as the to-be-written-off secondary voucher.

Algorithm and display provided herein are not inherently related to any specific computer, virtual system or other devices. Various general systems may be used together with teachings based on this. Based on the above descriptions, structures required for constructing such systems are obvious. Furthermore, the present disclosure is not specific to any specific programming language. It should be understood that the contents of the present disclosure described herein may be achieved using various programming languages and the above descriptions to the specific language are merely for disclosing the preferred embodiments of the present disclosure.

In the specification of the present disclosure, a large number of details are described. However, it is understood that the embodiments of the present disclosure may still be practiced without these specific details. In some embodiments, well-known methods, structures and technologies are not shown in details so as not to obscure the understanding of the present disclosure.

Similarly, it should be understood that in order to simplify the present disclosure and help understand one or more aspects of the present disclosure, various features of the present disclosure may sometimes be grouped together into a single embodiment, drawing, or their descriptions in the above descriptions of the exemplary embodiments of the present disclosure. However, the methods of the present disclosure shall not be explained to reflect the following intentions: the present disclosure claimed herein requires more features than clearly recorded in each claim of the appended claims. More specifically, as reflected by the following claims, the disclosed aspect includes fewer features than in a single embodiment disclosed previously. Therefore, the claims following the specific implementations are definitely incorporated into the specific implementations, where each claim itself serves as an individual embodiment of the present disclosure.

Those skilled in the art may understand that modules in a device of an embodiment may be adaptively changed and disposed in one or more devices different from the embodiment. The modules, units, or components in the embodiments may be combined into one module, unit or component and may also be separated into several sub-modules, sub-units or sub-components. Except for mutual exclusion of at least some of such features, and/or processes or units, all features disclosed in the specification (including accompanying claims, abstract and drawings) and all processes or units of any methods or devices disclosed this way may be combined in any combination. Unless otherwise clearly stated, each feature disclosed in the specification (including accompanying claims, abstract and drawings) may be replaced with an alternative feature capable of providing same, equivalent or similar purpose.

Furthermore, those skilled in the art should understand that although some embodiments described herein include some features rather than other features included in other embodiments, combinations of features of different embodiments are still in the scope of protection of the present disclosure and form different embodiments. For example, in the following claims, any one of the claimed embodiments may be used in any combination.

The embodiment of each component of the present disclosure may be implemented by hardware or by a software module running on one or more processors or by their combination. Those skilled in the art should understand that some or all functions of some or all components in the apparatus for writing off a times card voucher according to the embodiments of the present disclosure may be implemented by use of a microprocessor or a digital signal processor (DSP) in practice. The present disclosure may also be implemented as device or apparatus programs for executing part or all of the methods described herein (for example, computer programs and computer program products). The programs for implementing the present disclosure this way may be stored in a computer readable storage medium or may be in the form of one or more signals. Such signals may be downloaded from internet sites or provided by carrier signals or provided in any other form.

It is noted that the above embodiments are used to describe the present disclosure rather than limit the present disclosure, and those skilled in the art may design alternative embodiments without departing from the scope of the appended claims. In the claims, any reference symbols in parentheses shall not be intended to limit the claims. The word “include” does not preclude presence of an element or step not included in the claims. The words such as “one” and “a” appearing before an element do not preclude presence of a plurality of such elements. The present disclosure may be implemented by hardware including several different elements or by a properly-programmed computer. In unit claims listing a plurality of apparatuses, a plurality of these apparatuses may be implemented by a same hardware item. The words such as first, second and third do not refer to any sequence in use, and these words may be interpreted as names.

What is claimed is:

1. A method of creating a times card voucher, comprising:
receiving an acquisition request for a times card;
creating a primary voucher and at least one secondary voucher corresponding to the times card based on the acquisition request, wherein a number of the at least one secondary voucher is consistent with a number of times of use authorized for the times card; and
generating at least one of a first write-off code corresponding to the primary voucher, or a second write-off code corresponding to the at least one secondary voucher, so as to write off the at least one secondary voucher.

2. The method of claim 1, wherein after creating the primary voucher and the at least one secondary voucher corresponding to the times card based on the acquisition request, the method further comprises:
determining fund information allocated to each secondary voucher; and
recording the fund information in the corresponding secondary voucher for a fund settlement of a merchant side.

3. The method of claim 1, wherein before generating at least one of the first write-off code or the second write-off code, the method further comprises:
determining a write-off manner of the times card voucher; wherein the write-off manner comprises writing off based on the first write-off code, or writing off based on the second write-off code;
wherein generating at least one of the first write-off code or the second write-off code comprises at least one of:
in a case that the write-off manner of the times card voucher is determined as writing off based on the first write-off code, generating the first write-off code corresponding to the primary voucher; or,
in a case that the write-off manner of the times card voucher is determined as writing off based on the second write-off code, generating the second write-off code corresponding to the at least one secondary voucher.

4. The method of claim 3, wherein after the write-off manner of the times card voucher is determined as writing off based on the second write-off code, the method further comprises:
determining, from the at least one secondary voucher, one or more un-written-off secondary vouchers based on a write-off state of the at least one secondary voucher; and
selecting one secondary voucher from the un-written-off secondary vouchers as a to-be-written-off secondary voucher;
wherein generating the second write-off code corresponding to the at least one secondary voucher comprises:
generating the second write-off code corresponding to the to-be-written-off secondary voucher.

5. The method of claim 4, wherein determining the one or more un-written-off secondary vouchers based on the write-off state of the at least one secondary voucher comprises:
after the at least one secondary voucher is created or each time a write-off is completed for the to-be-written-off secondary voucher, determining the one or more un-written-off secondary vouchers based on the write-off state of the at least one secondary voucher.

6. The method of claim 4, wherein selecting one secondary voucher from the un-written-off secondary vouchers as the to-be-written-off secondary voucher comprises:
selecting one secondary voucher from the un-written-off secondary vouchers as the to-be-written-off secondary voucher based on voucher identifiers of the un-written-off secondary vouchers; or,
selecting one secondary voucher from the un-written-off secondary vouchers as the to-be-written-off secondary voucher based on fund information recorded in the un-written-off secondary vouchers.

7. The method of claim 1, wherein after generating at least one of the first write-off code or the second write-off code, the method further comprises:
sending the first write-off code or the second write-off code to a user side such that the user side provides the first write-off code or the second write-off code to a merchant side for writing off the at least one secondary voucher.

8. A method of writing off a times card voucher, comprising:
according to a write-off request for at least one secondary voucher of a times card, analysing a write-off code carried in the write-off request; wherein the write-off code is a first write-off code corresponding to a primary voucher of the times card or a second write-off code corresponding to one secondary voucher of the at least one secondary voucher of the times card; and a number of the at least one secondary voucher is consistent with a number of times of use authorized for the times card; and
selecting a to-be-written-off secondary voucher from the at least one secondary voucher corresponding to the times card based on an analysis result to write off the to-be-written-off secondary voucher.

9. The method of claim 8, wherein the write-off request for the at least one secondary voucher of the times card comprises: a write-off request for the at least one secondary voucher of the times card initiated by acquiring the write-off code from a user side by the merchant side;
after writing off the to-be-written-off secondary voucher, the method further comprises:
performing a fund settlement on a merchant side according to fund information recorded in the to-be-written-off secondary voucher.

10. The method of claims 8 wherein in a case that the write-off code is the first write-off code corresponding to the primary voucher of the times card, analysing the write-off code carried in the write-off request comprises:
analysing the first write-off code to determine the at least one secondary voucher associated with the primary voucher corresponding to the first write-off code;
wherein selecting the to-be-written-off secondary voucher from the at least one secondary voucher corresponding to the times card based on the analysis result comprises:
determining, from the at least one secondary voucher, one or more un-written-off secondary vouchers based on a write-off state of the at least one secondary voucher; and
selecting one secondary voucher from the un-written-off secondary vouchers as the to-be-written-off secondary voucher.

11. The method of claim 10, wherein selecting one secondary voucher from the un-written-off secondary vouchers as the to-be-written-off secondary voucher comprises:
selecting one secondary voucher from the un-written-off secondary vouchers as the to-be-written-off secondary voucher based on voucher identifiers of the un-written-off secondary vouchers; or,
selecting one secondary voucher from the un-written-off secondary vouchers as the to-be-written-off secondary voucher based on fund information recorded in the un-written-off secondary vouchers.

12. The method of claim 8 wherein in a case that the write-off code is the second write-off code corresponding to one secondary voucher of the at least one secondary voucher of the times card, analysing the write-off code carried in the write-off request comprises:
analysing the second write-off code to determine a secondary voucher corresponding to the second write-off code;
wherein selecting the to-be-written-off secondary voucher from the at least one secondary voucher corresponding to the times card based on the analysis result comprises:
selecting the secondary voucher corresponding to the second write-off code as the to-be-written-off secondary voucher.

13. A method of writing off a times card voucher, comprising:
receiving an acquisition request for a times card, and creating a primary voucher and at least one secondary voucher corresponding to the times card based on the acquisition request; wherein a number of the at least one secondary voucher is consistent with a number of times of use authorized for the times card;
according to a write-off request for the at least one secondary voucher of the times card, analysing a write-off code carried in the write-off request, wherein the write-off code is a first write-off code corresponding to the primary voucher, or a second write-off code corresponding to one secondary voucher; and
selecting a to-be-written-off secondary voucher from the at least one secondary voucher corresponding to the times card based on an analysis result to write off the to-be-written-off secondary voucher.

14. The method of claim 13, wherein after creating the primary voucher and the at least one secondary voucher corresponding to the times card based on the acquisition request for the times card, the method further comprises:
determining fund information allocated to each secondary voucher;
recording the fund information in the corresponding secondary voucher; and
after writing off the to-be-written-off secondary voucher, performing a fund settlement on a merchant side based on the fund information.

15. The method of claim 13 further comprising:
determining a write-off manner of the times card voucher; wherein the write-off manner comprises writing off based on the first write-off code or writing off based on the second write-off code.

16. The method of claim 15, wherein in a case that the write-off manner of the times card voucher is determined as writing off based on the first write-off code, the method further comprises:
generating the first write-off code corresponding to the primary voucher and sending the first write-off code to a user side such that the user side provides the first write-off code to the merchant side for writing off the at least one secondary voucher;
wherein analysing the write-off code carried in the write-off request comprises:
analysing the first write-off code carried in the write-off request and determining the at least one secondary voucher associated with the primary voucher corresponding to the first write-off code;
selecting the to-be-written-off secondary voucher from the at least one secondary voucher corresponding to the times card based on the analysis result comprises:
determining, from the at least one secondary voucher, one or more un-written-off secondary vouchers based on a write-off state of the at least one secondary voucher; and
selecting one secondary voucher from the un-written-off secondary vouchers as the to-be-written-off secondary voucher.

17. The method of claim 15, wherein in a case that the write-off manner of the times card voucher is determined as writing off based on the second write-off code, the method further comprises:
after the at least one secondary voucher is created or each time a write-off is completed for the to-be-written-off secondary voucher, determining, from the at least one secondary voucher, one or more un-written-off secondary vouchers based on the write-off state of the at least one secondary voucher;
selecting one secondary voucher from the un-written-off secondary vouchers; and
generating the second write-off code corresponding to the one secondary voucher and sending the second write-off code to a user side such that the user side provides the second write-off code to the merchant side for writing off the at least one secondary voucher;
wherein analysing the write-off code carried in the write-off request comprises:
analysing the second write-off code to determine a secondary voucher corresponding to the second write-off code;
selecting the to-be-written-off secondary voucher from the at least one secondary voucher corresponding to the times card based on the analysis result comprises:
selecting a secondary voucher corresponding to the second write-off code as the to-be-written-off secondary voucher.

18. (canceled)

19. (canceled)

20. (canceled)
